(19) United States
(12) Patent Application Publication
(10) Pub. No.: US 2007/0280777 A1
(43) Pub. Date: Dec. 6, 2007

(54) Sliding self-locking mechanism

(75) Inventor: Jun-Ming Fan, Guan-Jhou City (CN)

Correspondence Address: ROSENBERG, KLEIN & LEE, 3458 ELLICOTT CENTER DRIVE-SUITE 101, ELLICOTT CITY, MD, 21043, US

(73) Assignee: Lite-On Technology Corporation

(21) Appl. No.: 11/442,120

(22) Filed: May 30, 2006

(51) Int. Cl. F16J 1/22

(52) U.S. Cl. 403/25

(57) ABSTRACT

A sliding self-locking mechanism is located between a first linking element and a second linking element. The first linking element is movably assembled with the second linking element. The second linking element forms a receiving space and the sliding self-locking mechanism is located in the receiving space of the second linking element. When the first linking element is slidingly being installed with the second linking element at a predetermined location, the sliding self-locking mechanism movably locks the first linking element. The sliding self-locking mechanism can be implemented in large-scaled electronic devices having two modules. The first and second linking elements are individually assembled with a module for automatically locking two modules of an electronic device by a sliding method. It is convenient for the user to disassemble and assemble the modules, and maintain and package the modules. Its structure is simple and it only needs a small receiving space.

### BACKGROUND OF THE INVENTION

1. Field of the Invention

The present invention relates to a sliding self-locking mechanism. In particular, this invention relates to a linking mechanism for assembling and disassembling two modules of an electronic device by a sliding method.

2. Description of the Related Art

As photoelectric technology has developed, a variety of electronic devices have been developed, such as scanners, printers, fax machines, copy machines, and machines capable of multiple-functions. Multiple-function machines provide many functions, including scanning, printing, faxing, copying etc, and are popular in offices.

For a conventional multiple-function machine, the multiple-function machine usually includes a scanning unit and an outputting unit. The outputting unit is located under the scanning unit. The scanning unit is usually fastened with the outputting unit by locking into each other via a screw.

By using the above locking method involving a screw, when the scanning unit or the outputting unit of the multiple-function machine is assembled, when it needs its components replaced, or when the multiple-function machine is being disassembled due to a breakdown, it is difficult to disassemble the scanning unit or the outputting unit. Moreover, because both the scanning unit and the outputting unit are heavy and large, another person is needed to hold the scanning unit so that it doesn't fall when the multiple-function machine is being disassembled. It is inconvenient.

### SUMMARY OF THE INVENTION

One particular aspect of the present invention is to provide a sliding self-locking mechanism for automatically locking two modules of an electronic device by a sliding method. It is convenient for the user to disassemble and assemble the modules. It is also convenient for the user to maintain and package the modules. Its structure is simple and only occupies a small space.

The sliding self-locking mechanism is located between a first linking element and a second linking element. The first linking element is movably assembled with the second linking element. The second linking element forms a receiving space and the sliding self-locking mechanism is located in the receiving space of the second linking element. The sliding self-locking mechanism includes an interfering element extending downward from the first linking element, a supporting base received in the receiving space of the second linking element, a sliding block extending outward to form a locking rod and a linking rod movably installed to the supporting base. When the first linking element is slidingly being installed with the second linking element at a predetermined location, the locking rod locks the first linking element. The sliding self-locking mechanism further includes a flexible flake having a bottom located on the supporting base and a top contacting the interfering element, a touch-control element linked with a free end of the linking rod and located at another side of the supporting base that is opposite to the sliding block, and a flexible element located at another side of the sliding block that is opposite to the touch-control element for pushing the sliding block. The sliding block extends to the flexible flake to form a wedged hook. One side of the flexible flake near to the wedged hook forms a guiding flake. The wedged hook of the sliding block can selectively be slidingly linked with the guiding flake or wedged with the flexible flake.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a first exploded perspective view of the sliding self-locking mechanism of the present invention;

FIG. 2 is a second exploded perspective view of the sliding self-locking mechanism of the present invention;

FIG. 3 is a top view of the first linking element of the sliding self-locking mechanism of the present invention;

FIG. 4 is a third exploded perspective view of the sliding self-locking mechanism of the present invention;

FIG. 5 is a top view of the second linking element of the sliding self-locking mechanism of the present invention;

FIG. 6 is a cross-sectional view of the cross-sectional line 6-6 of FIG. 5;

FIG. 7 is an exploded perspective view of the sliding self-locking mechanism of the sliding self-locking mechanism of the present invention;

FIG. 8 is a first perspective view of the sliding self-locking mechanism of the sliding self-locking mechanism of the present invention;

FIG. 9 is a second perspective view of the sliding self-locking mechanism of the sliding self-locking mechanism of the present invention;

FIG. 10 is a first operation schematic diagram of the sliding self-locking mechanism of the present invention;

FIG. 11 is a second operation schematic diagram of the sliding self-locking mechanism of the present invention;

FIG. 12 is a third operation schematic diagram of the sliding self-locking mechanism of the present invention;

FIG. 13 is a first operation schematic diagram of another embodiment of the sliding self-locking mechanism of the present invention;

FIG. 14 is a second operation schematic diagram of another embodiment of the sliding self-locking mechanism of the present invention; and

FIG. 15 is a perspective view of the sliding element of the sliding self-locking mechanism of the present invention.

### DETAILED DESCRIPTION OF THE PREFERRED EMBODIMENTS

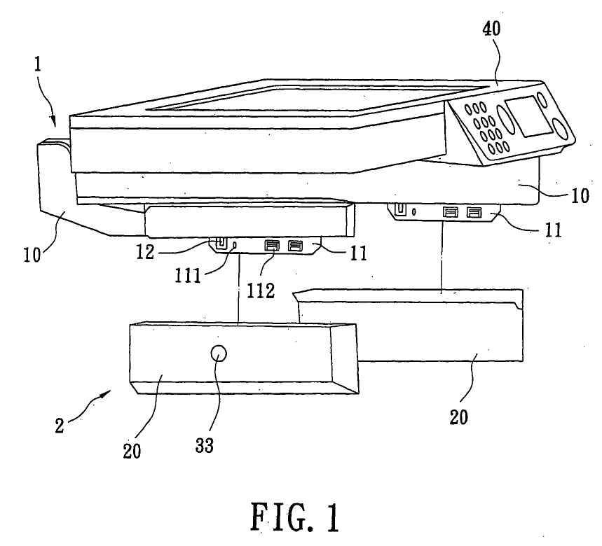

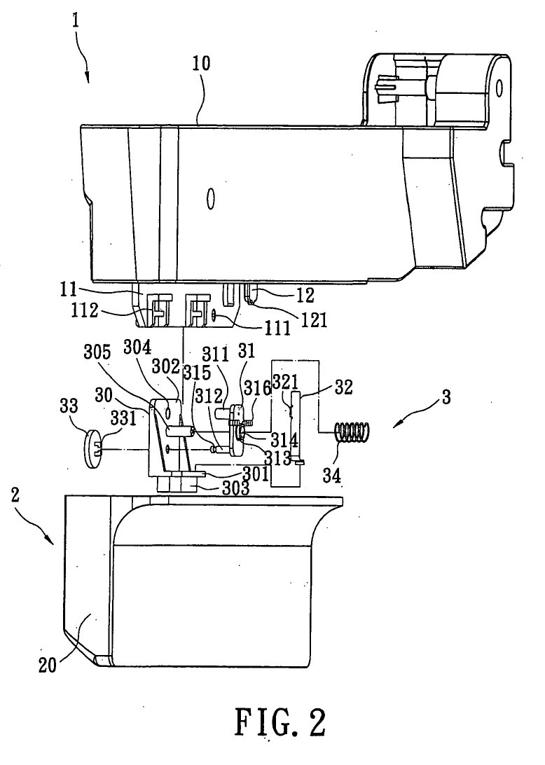

Reference is made to FIGS. 1 and 2. The sliding self-locking mechanism 3 of the present invention is used for linking a first module 1 and a second module 2 in an electronic device.

In this embodiment, a multiple-function machine is taken as an example to illustrate the first module 1 and the second module 2. The sliding self-locking mechanism 3 of the present invention is used particularly for linking two modules of large dimensions, such as a scanning unit and an outputting unit of a multiple-function machine, its size is large and it is heavy. Furthermore, the sliding self-locking mechanism 3 of the present invention can be applied in the printer, the copying machine, or the fax machine, etc. The sliding self-locking mechanism 3 of the present invention can also be applied in an electronic device having a smaller volume, such as a digital still camera and its charging module.

The first module 1 and the second module 2 fitting in with the sliding self-locking mechanism 3 are described. The first module 1 has a pair of first linking elements 10 that correspond to each other. In this embodiment, the first linking element 10 is installed at the bottom of the scanning unit 40 of the multiple-function machine. The second module 2 has a pair of second linking elements 20 that correspond to each other. The second linking element 20 is installed at the top of the outputting unit (not shown in the figure) of the multiple-function machine. The first linking element 10 is connected with the second linking element 20 by a sliding method.

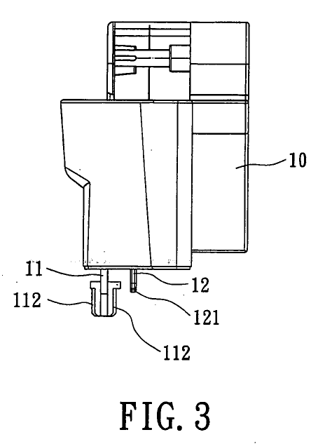

Reference is made to FIGS. 1-3. The first linking element 10 has a rectangular shape and individually extends downward to an assembly board 11 and an interfering element 12. The interfering element 12 is located at the inner side of assembly board 11 and is adjacent to the assembly board 11. The first linking element 10 is not limited to the above shape. For example, the pair of first linking elements 10 are connected with each other and are inverse U-shaped. The assembly board has a through hole 111. The through hole 111 is adjacent to the interfering element 12. As shown in FIG. 3, two sides of the assembly board 12 individually extend outward to form two pairs of positioning parts 112 that correspond to each other. One side of the interfering element 12 extends downward to form a push-contacting part 121 having an arc-shaped.

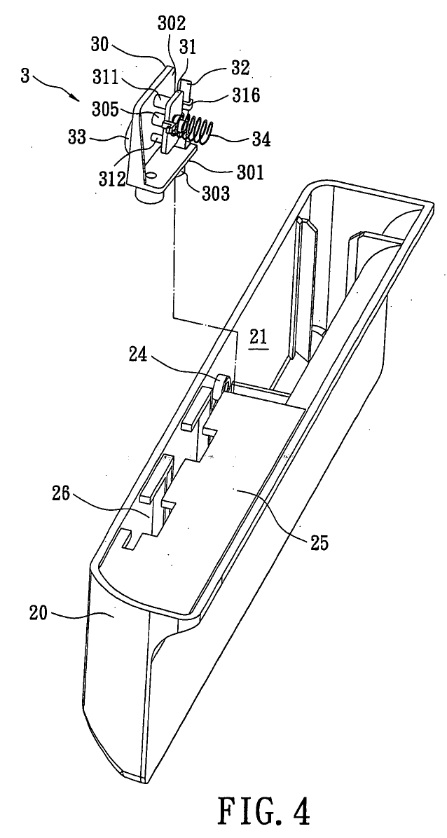

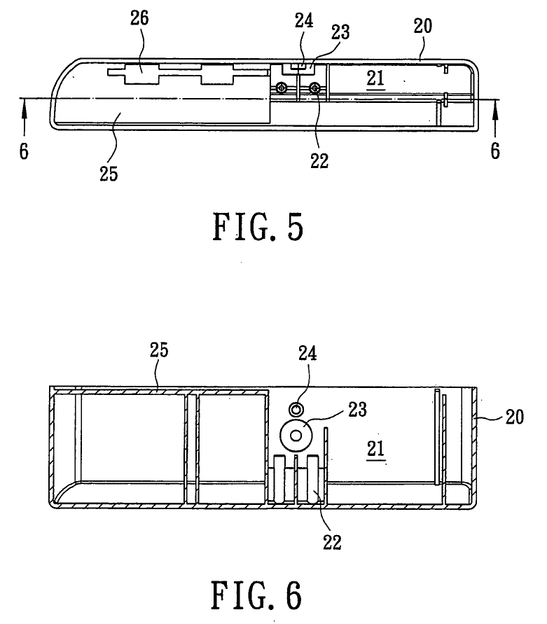

Reference is made to FIGS. 4-9. The second linking element 20 has a rectangular shape and has a receiving space 21. The second linking elements 20 have two pivoting shafts 22 that correspond to each other and protrude into the receiving space 21. The second linking elements 20 further have a guiding part 23 and a locking part 24 that protrude into the receiving space 21. The guiding part 23 and the locking part 24 each have a convex column hole. The second linking elements 20 further have a wedged area 25. The wedged area 25 is adjacently linked in the inner part of the receiving space 21 and is hollow. The wedged area 25 has two guiding openings 26 that correspond to each other.

The sliding self-locking mechanism 3 is installed between one of the first linking elements 10 and one of the second linking elements 20. In this embodiment, the sliding self-locking mechanism 3 is located in the second linking element 20. Reference is made to FIG. 4. The sliding self-locking mechanism 3 includes a supporting base 30, a sliding block 31, a flexible flake 32, a touch-control element 33, and a flexible element 34. The sliding block 31 extends outward to form a locking rod 311 and a linking rod 312 that are slidingly installed at the supporting base 30. Thereby, the sliding block 31 moves along a direction that is vertical to the supporting base 30.

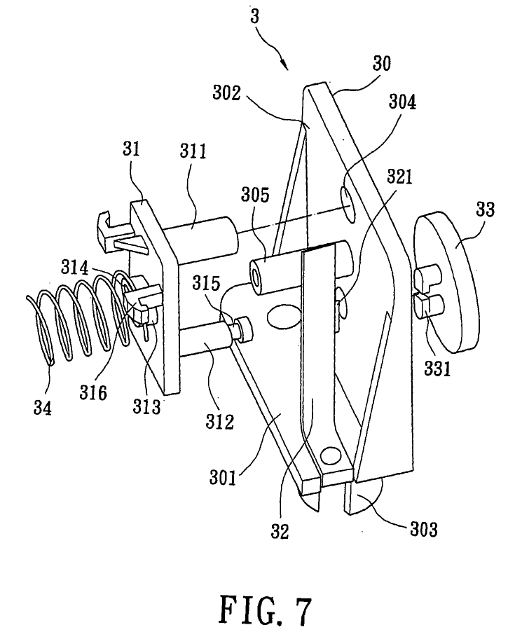

Reference is made to FIG. 7. The flexible flake 32 has a bottom and a top. The bottom is located at the supporting base 30, and the top contacts the interfering element 12 and is adjacent to the sliding block 31.

The touch-control element 33 is located at another side of the supporting base 30 and corresponds to the sliding block 31, and is jointed with one free end of the linking rod 312. When the user disassembles the modules, the touch-control element 33 is pressed to push the sliding block 31 for separating from the supporting base 30.

The flexible element 34 is located at another side of the sliding block 31 and corresponds to the touch-control element 33, and is pushed and contacted to the sliding block for pushing the sliding block 31. When the user releases the touch-control element 33, the flexible element 34 makes the sliding block 31 recover to its original location.

The supporting base 30 has a bottom 301. One side of the bottom 301 extends upward to form a side wall 302. The bottom side of the bottom 301 protrudes to form two pivoting parts 303. The two pivoting parts 303 are individually pivoted with the pivoting shafts 22 of the second linking element 20. The side wall 302 has two through holes 304 and a guiding rod 305. Another side of the sliding block 31 that corresponds to the locking rod 311 protrudes a protruding part 313 and a plugging hole 314. In this embodiment, the flexible element 34 is a compressed spring 34. One end of the flexible element 34 pushes and contacts to the protruding part 313. Another end of the flexible element 34 pushes and contacts the wall of the second linking element 20.

The guiding rod 305 of the supporting base 30 is slidingly installed into the plugging hole 314 of the sliding block 31. The locking rod 311 and the linking rod 312 of the sliding block 31 individually pass through the two through holes 304 of the supporting base 30. The linking rod 312 of the sliding block 31 is also exposed from the guiding part 23 of the second linking element 20. On the free end of the linking rod 312, there is a wedged slot 315. There are two wedged fasteners 311 protruding from one side of the touch-control 33 for wedging with the wedged slot 315 of the linking rod 312 so as to make the toughing element connect with the end of the linking rod 312. The touch-control 33 is located out side of the second linking element 20.

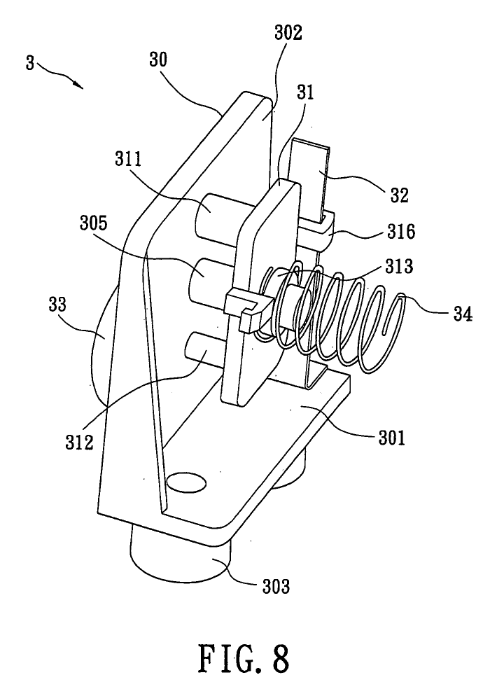

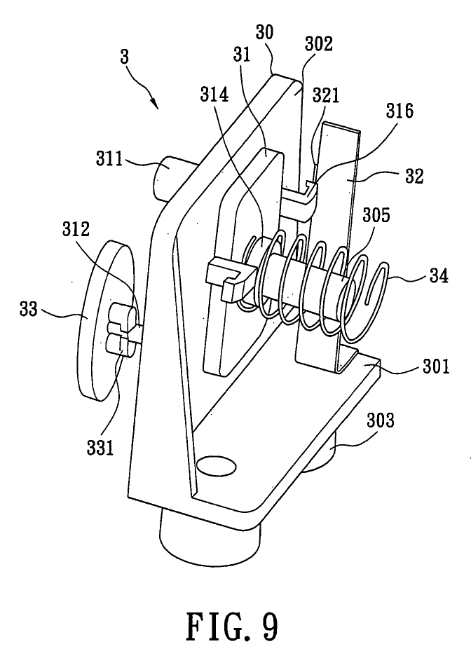

The locking rod 311 of the sliding block 31 corresponds to the locking part 24 of the second linking element 20. The locking rod 311 is slidingly plugged into the locking part 24. A wedged hook 316 extends from the sliding block 31 and faces towards the flexible flake 32. One side of the flexible flake 32 that is adjacent to the wedged hook 316 extends outward to form a guiding flake 321 having an arc shape. The wedged hook 316 of the sliding block 31 is slidingly connected with the guiding flake 321 (as shown in FIG. 9) or is wedged with the flexible flake 32 (as shown in FIG. 8).

Reference is made to FIGS. 2 and 4. The first linking elements 10 are slidingly assembled with the pair of second linking elements 20. The positioning parts 112 of the assembly board 11 are individually guided and enter into the guiding openings 26 of the wedged area 25 so as to push the first linking element 10 to make the first linking element 10 fasten onto the wedged area 25 of the pair of the second linking elements 20. Thereby, a stable first linking point is generated. When the first linking element 10 is slidingly installed to the second linking element 20 at a predetermined location, the flexible element 34 pushes the sliding block 31 so as to make the locking rod 311 of the sliding block 31 slidingly pass into the through hole 111 of the assembly board 11 and the locking part 24 of the second linking element 20. Thereby, the sliding self-locking mechanism 3 locks the first linking element 10 of the first module 1 to generate a stable second linking point.

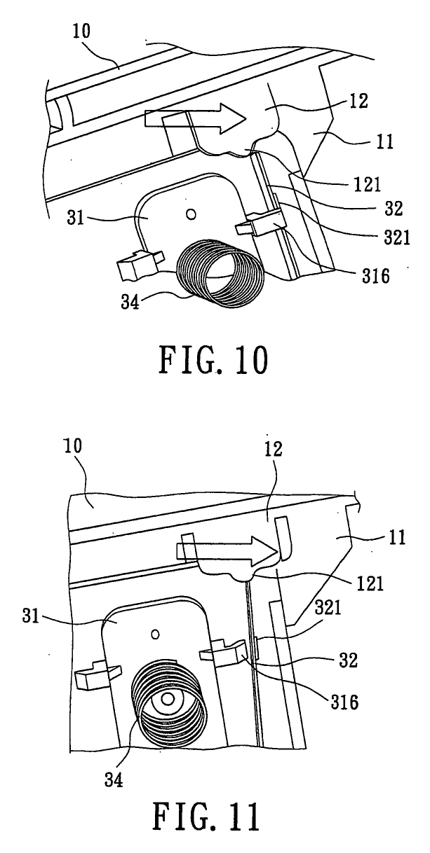

Reference is made to FIG. 10. The wedged hook 316 of the sliding block 31 wedges and fastens the flexible flake 32, and the top of the flexible flake 32 interferes the push-contacting part 121 located at the bottom of the interfering element 12 of the first linking element 10 so as to make the first linking element 10 fasten.

Reference is made to FIG. 11. When the sliding self-locking mechanism 3 is being disassembled, the user merely pushes the touch-control element 33 to make the sliding block 31 separate from the flexible flake 32. At this moment, the user pushes the module of the first linking element 10 to make the top of the flexible flake 32 that interferes with the push-contacting part 121 located at the bottom of the interfering element 12 of the first element 10 move the flexible flake 32 so as to separate from the wedged hook 316. The sliding block 31 is moved outward. When the user releases the touch-control element 33, the sliding block 31 automatically goes back to the original location due to the flexible element 34 to make the locking rod 311 lock the first linking element 10. At this moment, the flexible flake 32 is located on the outside of the wedged hook 316 of the sliding block 31.

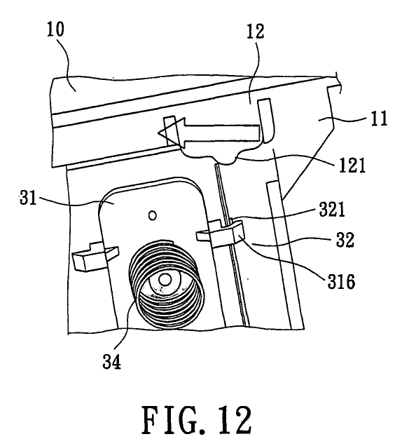

Reference is made to FIG. 12. When the module of the first linking element 10 is disassembled, the user merely needs to push the touch-control element 33 so as to make the sliding block 31 move and the wedged hook 316 wedge the flexible flake 32. At this moment, the locking rod 311 slides to the flexible element 34 to separate from the first linking element 10. Thereby, the module of the first linking element 10 is disassembled. The top of the flexible flake 32 interferes the push-contacting part 121 located at the bottom of the interfering element 12 of the first linking element 10 again to make the flexible flake 32 wedge the wedged hook 316 and move to the sliding block 31. After the module of the first linking element 10 is disassembled, the flexible flake 32 returns to its original location and the wedged hook 316 wedges and fastens the flexible flake 32.

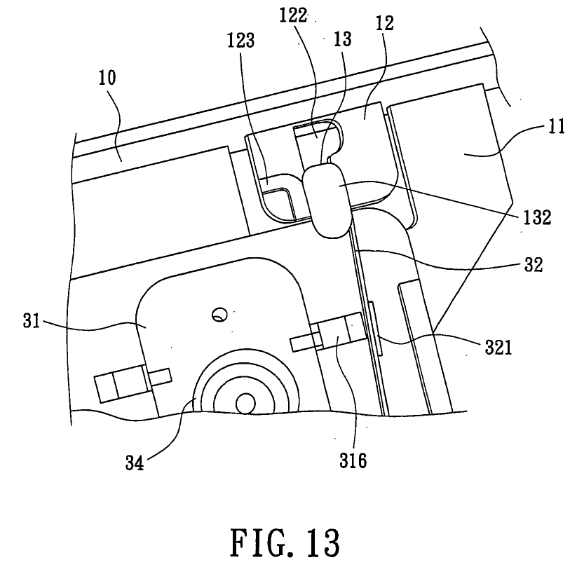

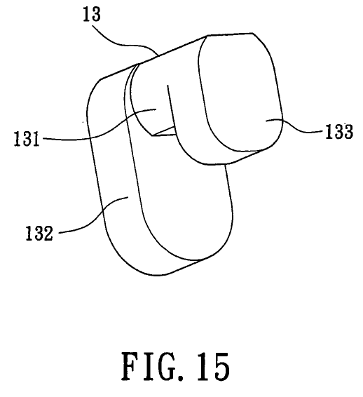

As shown in FIGS. 13, 14 and 15, which show another embodiment of the operating method between the interfering element 12 and the flexible flake 32. The interfering element 12 of the first linking element 10 further includes a sliding element 13 and the interfering element 12 has a sliding slot 122 and a supporting part 123. The sliding element 13 is slidingly installed in the sliding slot 122. The supporting part 123 pushes and contacts the sliding element 13, fastening one direction of the sliding element 13. The sliding element 13 has a body 131. A push-contacting part 132 and a fixing part 133 extend outward from the two sides of the body 131. The push-contacting part 132 corresponds to the fixing part 133. The body 131 is installed in the sliding slot 122 to make the push-contacting part 132 sliding push and contact the flexible flake 32.

When the module on the first linking element 10 is fastened with the module located under the second linking element 20, the left side of the push-contacting part 132 of the sliding element 13 pushes and contacts the supporting part 123 of the interfering element 12 and the right side of the push-contacting part 132 pushes and contacts the top of the flexible flake 32. Thereby, the module on the first linking element is moved and the push-contacting part 132 of the sliding element 13 pushes the flexible flake 32 to make the flexible flake 32 move outward and separate from the wedged hook 316 (as shown in FIG. 13).

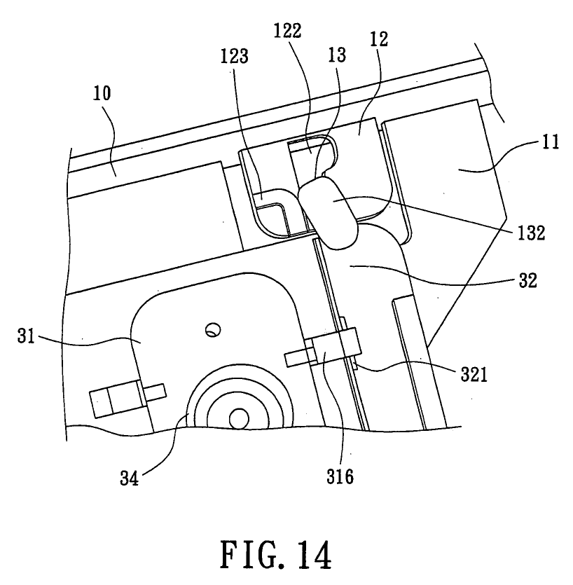

When the module on the first linking element 10 is disassembled, the top of the flexible flake 32 pushes and contacts the left side of the push-contacting part 32 to push the module on the first linking element 10 again. The flexible flake 32 makes the sliding element 13 move upward in the sliding slot 122 (as shown in FIG. 14). Thereby, the function the same as the push-contacting part 121 of the interfering element 12 is provided.

The present invention has the following characteristics:

1. The first module 1 is slidingly assembled with the second module 2 via the first linking element 10 and the second linking element 20. It is easy for the user to assemble the first module 1 with the second module 2, and a stable first linking point is provided.

2. When the sliding self-locking mechanism 3 is used for assembling the first linking element 10 with the second linking element 20, the sliding self-locking mechanism 3 utilizes the movement between the interfering element 12 and the flexible flake 32 and utilizes the flexible element 34 to move the locking rod 311 of the sliding block 31 so as to lock the first linking element 10. The self-locking effect is achieved. It is convenient to package the modules and a stable second linking point is provided.

3. When the user disassembles the first module 1, the touch-control element 33 is pressed to make the locking rod 311 of the sliding lock 31 move and separate from the first linking element 10. The wedged hook 316 wedges the flexible flake 32 and fastens the sliding block 31. Therefore, the first linking element is disassembled to make the first module 1 separate from the second module 2. It is easy to disassemble the first module 1 and the second module 2, and it is convenient to maintain the devices.

4. The structure of the sliding self-locking mechanism 3 is simple, its size small and the required space for the devices is small. It can also be used in modulated electronic devices.

5. The two embodiments achieve the same effect. The preset invention provides the operating method between the interfering element 12 of the first linking element 10 and the flexible flake 32 to achieve the self-locking function via the flexile flake 32.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A sliding self-locking mechanism, located between a first linking element and a second linking element, the first linking element is slidingly assembled with the second linking element and the second linking element forms a receiving space, comprising:
an interfering element extending downward from the first linking element;
a supporting base received in the receiving space of the second linking element;
a sliding block extending outward to form a locking rod and a linking rod, wherein the locking rod and a linking rod are slidingly installed at the supporting base, and when the first linking element is slidingly located the second linking element to a predetermined location, the locking rod locks the first linking element;
a flexible flake having a bottom located on the supporting base and a top contacting with the interfering element;
a touch-control element linked with a free end of the linking rod and located at another side of the supporting base that is opposite to the sliding block; and
a flexible element located at another side of the sliding block that is opposite to the touch-control element for pushing the sliding block;
wherein the sliding block extends to the flexible flake to form a wedged hook, and one side of the flexible flake near to the wedged hook forms a guiding flake and the wedged hook of the sliding block is slidingly linked with the guiding flake or wedged with the flexible flake.

2. The sliding self-locking mechanism as claimed in claim 1, wherein the first linking element extends outward to form an assembly board and the assembly board has a through hole, and the second linking element further has a locking part protruding from the receiving space, wherein the locking rod slidingly passes through the through hole and the locking part and movably locks the first linking element.

3. The sliding self-locking mechanism as claimed in claim 2, wherein two sides of the assembly board individually extend outward to form two pairs of positioning parts, and the second linking elements further have a wedged area and the wedged area is adjacently linked in the inner part of the receiving space, wherein the wedged area has two guiding openings, the positioning parts of the assembly board are individually guided into the guiding openings of the wedged area to push the first linking element to make the first linking element be fastened in the wedged area.

4. The sliding self-locking mechanism as claimed in claim 1, wherein one side of the interfering element further extends downward to form a push-contacting part, and the top of the flexible flake slidingly pushes and contacts the push-contacting part.

5. The sliding self-locking mechanism as claimed in claim 1, wherein the interfering element further comprises a sliding element, and the interfering element has a sliding slot and the supporting part, wherein the sliding element is slidingly installed in the sliding slot, and the supporting part pushes and contacts the sliding element and fastens one direction of the sliding element.

6. The sliding self-locking mechanism as claimed in claim 5, wherein the sliding element has a body, and a push-contacting part and a fixing part extend outward from the two sides of the body, wherein the push-contacting part corresponds to the fixing part, and the body is installed in the sliding slot to make the push-contacting part slidingly push and contact the flexible flake.

7. The sliding self-locking mechanism as claimed in claim 1, wherein the second linking elements have two pivoting shafts that protrude into the receiving space, and the supporting base has a bottom, wherein the bottom has two pivoting parts and the two pivoting parts are individually pivoted with the two pivoting shafts.

8. The sliding self-locking mechanism as claimed in claim 1, wherein the second linking elements further have guiding parts that protrude into the receiving space, and the linking rod passes through the guiding part and is exposed form the guiding part, wherein one free end of the linking rod further comprises a wedged slot and one side of the touch-control element has two wedged fasteners that wedge in the wedged slot to make the touch-control element be located out of the second element.

9. The sliding self-locking mechanism as claimed in claim 1, wherein the supporting base has a bottom and one side of the bottom extends upward to form a side wall, wherein the side wall has two through holes and a guiding rod, the sliding block has a protruding part having a plugging hole, and the plugging hole of the sliding block is slidingly installed at the guiding rod to make the locking rod and the linking rod individually pass through the two through holes.

10. The sliding self-locking mechanism as claimed in claim 9, wherein the flexible element is a compressed spring, one end of the flexible element pushes and contacts the protruding part and another end of the flexible element pushes and contacts the side wall of the second linking element.
